(19) United States
(12) Patent Application Publication
(10) Pub. No.: US 2026/0200216 A1
(43) Pub. Date: Jul. 16, 2026

(54) FILM AND ARTICLE COMPRISING THE SAME

(71) Applicant: W.L. Gore & Associates G.K., Tokyo (JP)

(72) Inventor: Hiroki Sadato, Tokyo (JP)

(21) Appl. No.: 19/137,800

(22) PCT Filed: Dec. 14, 2022
(86) PCT No.: PCT/IB2023/000744

§ 371 Date: Jun. 11, 2025

Related U.S. Application Data
(60) Provisional application No. 63/387,395, filed on Dec. 14, 2022.

(51) Int. Cl. B32B 27/08; B32B 3/26; B32B 27/32

(52) U.S. Cl. CPC B32B 27/08; B32B 3/26; B32B 27/32; B32B 2250/02; B32B 2255/10; B32B 2307/306; B32B 2307/406; B32B 2307/41; B32B 2307/54; B32B 2307/724; B32B 2307/728; B32B 2307/748

(57) ABSTRACT

A film including A.) a microporous polyethylene membrane, wherein the microporous polyethylene membrane includes polyethylene, wherein the polyethylene has a weight average molecular weight of greater than 500,000 grams/mole, wherein the microporous polyethylene membrane has a porosity of at least 40 vol %, and wherein the microporous polyethylene membrane has a Gurley number of less than 200 seconds! and B) a. hydrophilic polymer, wherein some of the hydrophilic polymer is within at least a portion of pores of the microporous polyethylene membrane, and at least some of the hydrophilic polymer forms a cap layer existing on at least one surface of the microporous polyethylene membrane, and wherein the cap layer is essentially free from voids.

### TECHNICAL FIELD OF THE DISCLOSURE

The present disclosure relates to a waterproof, breathable film and an article comprising the film that are useful in a variety of applications. The films can be used by themselves or can be laminated to other layers to form multilayer laminates.

### BACKGROUND OF THE DISCLOSURE

Garments and other types of apparel, such as shoes, gloves and hats often incorporate a waterproof breathable layer to keep a wearer dry in wet conditions. These garments can be formed using laminates of the breathable waterproof layer and one or more textiles. Composite waterproof breathable films made using porous PTFE membranes and hydrophilic polyurethane are currently being used to make textile laminates such as those commercialized by W.L. Gore & Associates of Newark, Delaware under the trade name GORE-TEX®. The PTFE membranes are microporous and generally hydrophobic wherein the pore size of the membrane is larger than individual molecules of water, but the pores are much smaller than drops of water. Water vapor is able to pass through the material while water droplets are prevented from passing from one side of the membrane to the other.

While PTFE microporous membranes work well, porous polyurethane membranes have also been developed for use in apparel, but these membranes can lack durability and, in some cases, can be dissolved by certain commonly used products, for example, nail polish or bug sprays. These membranes can also have limitations where the membrane is stiff and noisy when the wearer moves.

Composite membranes in which a hydrophilic polymer is coated on a porous membrane such as polyethylene have also been considered, but the following concerns exist. Exemplarily, since porous materials such as polyethylene have relatively low heat resistance, it is difficult to select a hydrophilic polymer or its curing agent with a high reaction temperature (e.g., curing temperature), in view of a process temperature therebetween. In addition, the coated hydrophilic polymer and curing agent may react with moisture (or humidity) in the atmosphere or chemical reaction of curing agent etc., so as to generate gas, which may affect the surface properties (e.g., appearance, etc.,) of the coating.

### SUMMARY OF THE DISCLOSURE

### Technical Problem

There is a continuing need to produce films (being essentially free from voids) that have a variety of appearance of an article, such as a garment, incorporating the film.

### Solution to Problem

The disclosure relates to a first embodiment that is a film including:
A) a microporous polyethylene membrane including:
   i) a weight average molecular weight of greater than 500,000 grams/mole;
   ii) a porosity of at least 40 vol %;
   iii) a Gurley number of less than 200 seconds;
B) a hydrophilic polymer wherein at least some of the hydrophilic polymer is within at least a portion of the pores of the microporous polyethylene membrane, and at least some of the hydrophilic polymer includes a cap layer existing on at least one surface of the microporous polyethylene membrane;
   wherein the cap layer is essentially free from voids.

The disclosure also relates to articles including at least one of the films.

In a second embodiment the disclosure relates to the film of embodiment 1 wherein substantially all of the pores of the microporous polyethylene membrane are filled with the hydrophilic polymer.

In a third embodiment the disclosure relates to the film of any one of embodiments 1 or 2 wherein the film further includes a release layer, and the release layer is adjacent to the cap layer.

In a fourth embodiment the disclosure relates to the film of any one of embodiments 1 to 3 wherein the cap layer has a controlled surface morphology.

In a fifth embodiment the disclosure relates to the film of any one of embodiments 1 to 4 wherein the controlled surface morphology includes a transfer printed surface from a release layer placed on the cap layer.

In a sixth embodiment the disclosure relates to the film of any one of embodiments 1 to 5 wherein the film has an opacity of from 10 to 85.

In a seventh embodiment the disclosure relates to the film of any one of embodiments 1 to 6 wherein the film has a heat resistance of no more than 190 degree C.

In an eighth embodiment the disclosure relates to the film of any one of embodiments 1 to 7 wherein the film has a tensile strength of 0.45 kgf or more in the MD direction.

In a ninth embodiment the disclosure relates to the film of any one of embodiments 1 to 8 wherein having a tensile strength of 0.36 kgf or more in the TD direction.

In a tenth embodiment the disclosure relates to the film any one of embodiments 1 to 9 wherein the hydrophilic polymer includes a polyurethane, polyamide, polyester, epoxy resin, silicone resin, ionomer, or a copolymer or a combination thereof.

In an eleventh embodiment the disclosure relates to the film of any one of embodiments 1 to 10 wherein the film has a Gurley number of 1000 seconds or more.

In a twelfth embodiment the disclosure relates to the film of any one of embodiments 1 to 11 wherein the film has a surface gloss of 3.0 gloss units or more.

In a thirteenth embodiment the disclosure relates to the film of any one of embodiments 1 to 12 wherein the film has a MVTR of 2500 g/m²/day or more.

In a fourteenth embodiment the disclosure relates to an article including the film of any one of embodiments 1 to 13.

In some embodiments, a film includes A) a microporous polyethylene membrane, wherein the microporous polyethylene membrane includes polyethylene, wherein the polyethylene has a weight average molecular weight of greater than 500,000 grams/mole, wherein the microporous polyethylene membrane has a porosity of at least 40 vol %, and wherein the microporous polyethylene membrane has a Gurley number of less than 200 seconds; and B) a hydrophilic polymer, wherein some of the hydrophilic polymer is within at least a portion of pores of the microporous polyethylene membrane, and at least some of the hydrophilic polymer forms a cap layer existing on at least one surface of the microporous polyethylene membrane, and wherein the cap layer is essentially free from voids.

In some embodiments, wherein the hydrophilic polymer within the microporous polyethylene membrane fills substantially all of the pores of the microporous polyethylene membrane.

In some embodiments, the film also includes a release layer, wherein the release layer is adjacent to the cap layer.

In some embodiments, wherein the cap layer has a controlled surface morphology. In some embodiments, the controlled surface morphology includes a transfer printed surface from a release layer placed on the cap layer.

In some embodiments, the film has an opacity of from 10 to 85.

In some embodiments, the film has a heat resistance of no more than 190 degrees C.

In some embodiments, the film has a tensile strength of 0.45 kgf or more in a MD direction.

In some embodiments, the film has a tensile strength of 0.36 kgf or more in a TD direction.

In some embodiments, the hydrophilic polymer includes a polyurethane, a polyamide, a polyester, an epoxy resin, a silicone resin, an ionomer, or a copolymer or a combination thereof.

In some embodiments, the film has a Gurley number of 1000 seconds or more.

In some embodiments, the film has a surface gloss of 3.0 gloss units or more.

In some embodiments, the film has a moisture vapor transmission rate of 2500 g/m2/day or more.

In some embodiments, an article includes any of the films described above.

### Advantageous Effects of Invention

The film has a cap layer being essentially free from voids, and the hydrophilic polymer fills at least a portion of the pores of the porous polyethylene film, which reduce diffuse reflection of light by voids and therefore it is easy to obtain the desired appearance. In addition, it is easy to control the surface morphology of the cap layer of the film. Furthermore, it is easy to obtain excellent waterproof ability and breathability.

### BRIEF DESCRIPTION OF THE FIGURES

FIG. 1 shows a scanning electron micrograph (SEM) of a film including a conventional cap layer, in which the cap layer contains voids and the surface becomes uneven.

FIG. 2 shows an SEM of the cap layer in accordance with one of the embodiments of the invention, in which the cap layer does not contain voids.

FIG. 3A shows an SEM of a relatively smooth surface morphology of the release layer.

FIG. 3B shows a surface morphology of a cap layer after the release layer is removed.

FIG. 4A shows the SEM of a relatively rough surface morphology of the release layer.

FIG. 4B shows surface morphology of a cap layer after the release layer is removed.

FIG. 5 shows the SEM of a cubic patterned surface morphology transferred from the surface of the release layer.

### DETAILED DESCRIPTION

The disclosures of all cited patent and non-patent literature are incorporated herein by reference in their entirety.

As used herein, the term “embodiment” or “disclosure” is not meant to be limiting, but applies generally to any of the embodiments defined in the claims or described herein. These terms are used interchangeably herein.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The features and advantages of the present disclosure will be more readily understood by those of ordinary skill in the art from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described as a combination in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both preceded by the word “about”. In this manner, slight variations above and below the stated ranges can be used to achieve substantially the same results as values within the ranges. Also, the disclosure of these ranges is intended as a continuous range including each and every value between the minimum and maximum values.

As used herein, the term “membrane” means a polymer in the form of an essentially two-dimensional sheet, wherein the length and the width are both much greater than the thickness, for example both the length and the width are at least 100 times the thickness. In some embodiments, the membrane is a microporous membrane having a structure that allows, for example, water vapor to pass through the thickness of the membrane without liquid water being able to penetrate from one side of the membrane to the other. On average, the pore size is on the order of several nanometers to approximately one micrometer.

The term “film” means a membrane wherein the pores have been at least partially filled with a polymer such that the flow of gases or liquids does not occur through open pore channels in the membrane. In some embodiments, the polymer at least partially filling the pores can be a hydrophilic polymer.

The term “hydrophilic polymer” refers to a polymer that can allow substantial amounts of water to be transferred through the film by absorbing water on one side of the film where the water concentration is higher and desorbing or evaporating it on the opposite side of the film where the water vapor concentration is lower. In some embodiments, a layer of the hydrophilic polymer that is 10 micrometers thick can have a moisture vapor transmission rate of greater than or equal to 5,000 g/meter²/day, or greater than or equal to 10,000 g/meter²/day.

The phrases “microporous polyethylene membrane” “porous polyethylene membrane” and “polyethylene membrane” are used interchangeably throughout the specification. Unless specifically stated otherwise, these phrases mean a microporous polyethylene membrane having D) a weight average molecular weight greater than 500,000 g/mol: ii) a porosity of at least 40%; and iii) a Gurley number of less than 200 seconds. Under magnification, the porous polyethylene membrane shows a fibrillated structure of polyethylene fibrils, and with sufficient magnification it is possible to see one or more polyethylene fibrils, optionally three or more of the fibrils can be interconnected by one or more intersections of the three or more fibrils.

As used herein, the term “polyethylene” means a polyethylene polymer having less than 5 percent by weight of one or more comonomers. In some embodiments, the polyethylene is free from any fluorine containing comonomers, and, in still further embodiments, the polyethylene is polyethylene homopolymer.

The present disclosure relates to a film comprising A) a microporous polyethylene membrane, B) a hydrophilic polymer wherein at least some of the hydrophilic polymer fills at least a portion of the pores of the porous polyethylene membrane and at least some of the hydrophilic polymer is referred to be as a cap layer existing on at least one surface of the microporous polyethylene membrane, and wherein the cap layer is essentially free from voids. This film may not leak due to contamination by oils, detergents or other contact angle reducing materials and as such it is waterproof. Furthermore, articles comprising the film may have greater durability in the field and in the wash than other non-air permeable hydrophilic films that do not include the porous polyethylene membrane as a structural support. The porous polyethylene membrane may have a weight average molecular weight of greater than 500,000 grams per mole (g/mol) (e.g., may be formed from polyethylene having a weight average molecular weight of greater than 500,000 grams per mole (g/mol). In some embodiments, the porous polyethylene membrane has a weight average molecular weight of greater than 750,000 g/mol (e.g., may be formed from polyethylene having a weight average molecular weight of greater than 750,000 grams per mole (g/mol)). In still further embodiments, the porous polyethylene membrane has a weight average molecular weight of greater than 1,000,000 g/mol (e.g., may be formed from polyethylene having a weight average molecular weight of greater than 1,000,000 grams per mole (g/mol)). In still further embodiments, the polyethylene membrane has a weight average molecular weight of greater than 1,500,000 grams per mole or greater than to 1,750,000 grams per mole (e.g., may be formed from polyethylene having a weight average molecular weight of greater than 1,500,000 grams per mole (g/mol) or greater than 1,750,000 grams per mole (g/mol)). In still further embodiments, the polyethylene membrane has a weight average molecular weight of greater than 2,000,000 grams per mole, 3,000,000 grams per mole, 4,000,000 grams per mole, 5.000,000 grams per mole or greater than 8,000,000 grams per mole (e.g., may be formed from polyethylene having a weight average molecular weight of greater than 2.000,000 grams per mole (g/mol), or greater than 3,000,000 grams per mole, or greater than 4,000,000 grams per mole, or greater than 5,000,000 grams per mole, or greater than 8,000,000 grams per mole).

The microporous polyethylene membrane is a porous polyethylene membrane wherein the membrane has a porosity of at least 40 vol %. In some embodiments, the porosity of the porous polyethylene membrane can be at least 50 vol % or at least 60 vol % or at least 70 vol % or at least 80 vol %. The porosity, f, of the membrane can be calculated by measuring the mass per unit area of the membrane, MPA, and the thickness of the membrane, t, and using the relationship f=(1−MPA/(t*p))*100, where p is the density of the membrane polymer. The porous polyethylene membrane can also have a Gurley of less than 200 seconds or less than 100 seconds or less than or equal to 90 seconds or less than or equal to 80 seconds or less than or equal to 70 seconds or less than or equal to 60 seconds or less than or equal to 50 seconds or less than or equal to 40 seconds or less than 10 seconds.

The microporous polyethylene membrane can have a relatively light weight, for example, less than or equal to 10 grams per meter₂ (gsm). In other embodiments, the porous polyethylene membrane can have a weight of less than or equal to 9 gsm or less than or equal to 8 gsm or less than or equal to 7 gsm or less than or equal to 6 gsm or less than or equal to 5 gsm or less than or equal to 4 gsm or less than or equal to 3 gsm or less than or equal to 2 gsm.

The microporous polyethylene membrane can be colored or uncolored. The use of a porous polyethylene membrane can provide a valuable aesthetic quality to the film and articles comprising the film, especially when the porous polyethylene membrane is visible in the article. Any of the known colorization methods can be used. For example, the porous polyethylene membrane can be pigmented throughout the bulk of the membrane via the addition of pigments or dyes during the membrane formation process. In other embodiments, the porous polyethylene membrane can be colorized after formation via known printing and dyeing processes. In still further embodiments, the porous polyethylene membrane can be free from or essentially free from any added color and color can be added at one or more steps during the film formation processes described herein.

The film also comprises a hydrophilic polymer that fills at least a portion of the pores of the microporous polyethylene membrane. The phrase “filling at least a portion of the pores” means that the hydrophilic polymer is imbibed into the pores of the polyethylene membrane and fills the pores to the point that no airflow (a Gurley number of greater than or equal to 1000 seconds) can be determined through the area of the film containing the hydrophilic polymer. In other words, the hydrophilic polymer is not simply a coating on the walls of the polyethylene membrane that define the pores. While some voids may be present, it is thought that the hydrophilic polymer forms a contiguous layer within the area of the porous polyethylene membrane to which the hydrophilic polymer is applied. In other embodiments, the hydrophilic polymer forms a continuous layer free from or essentially free from any voids within the area of the porous polyethylene membrane to which the hydrophilic polymer is applied. In still further embodiments, substantially all of the pores of the porous polyethylene membrane are filled with the hydrophilic polymer. The hydrophilic polymer may fill across the microporous polyethylene membrane to the edges of the membrane in the direction of the thickness of the membrane.

As used in the specification, the term “essentially” or “substantially” is defined as largely but not necessarily wholly what is specified (and includes what is specified), as understood by a person of ordinary skill in the art, that is within a range that is suitable to bring about the intended purpose or function.

For example, “essentially free from voids” may mean an area ratio of voids in a cross-sectional observation being a few percent or less, e.g., 1% or less, 2% or less, 3% or less, 4% or less, 5% or less, 6% or less, 7% or less, 8% or less, 9% or less, or 10% or less. In addition, “substantially all of pores are filled” may mean an area ratio of part which are not filled in the pores in a cross-sectional observation being a few percent or less, e.g., 1% or less, 2% or less, 3% or less, 4% or less, 5% or less, 6% or less, 7% or less, 8% or less, 9% or less, or 10% or less.

The polyethylene membrane has a first side and a second side. The hydrophilic polymer can be applied to the first side of the porous polyethylene membrane and the hydrophilic polymer can permeate at least a portion of the pores to form the film, resulting in filling at least a portion of the pores of the polyethylene membrane. Furthermore, the first side of the polyethylene membrane comprises a cap layer of the hydrophilic polymer on the exterior of the membrane. The hydrophilic polymer constituting the cap layer is the same hydrophilic polymer as the hydrophilic polymer being within (or filling) at least a portion of the pores of the polyethylene membrane. However, those hydrophilic polymers are present in different locations. In addition, those hydrophilic polymers are in communication therewith, for example, they are in communication with through the first side of the porous polyethylene membrane. The cap layer or amount of the hydrophilic polymer on the first side of the porous polyethylene membrane has essentially no upper limit.

However, if the cap layer is too thick, then the beneficial properties of the porous polyethylene membrane cannot be realized (e.g., lightweight, etc.), therefore, the upper limit of the cap is about 50 micrometers. In some embodiments, the cap layer of the hydrophilic polymer can be up to 40 micrometers or up to 30 micrometers or up to 20 micrometers or up to 15 micrometers thick on the first surface of the polyethylene membrane. In some embodiments, the cap layer of the hydrophilic polymer can be up to about 10 micrometers thick on the first surface of the polyethylene membrane. In other embodiments, the cap layer on the first side of the polyethylene membrane is less than or equal to 10 micrometers thick, or less than or equal to 8 micrometers or less than or equal to 6 micrometers or less than or equal to 4 micrometers or less than or equal to 2 micrometers. The second side of the polyethylene membrane can bo essentially free from any of the hydrophilic polymer on the surface, for example, no hydrophilic polymer of a thickness more than 1 micrometer above the surface of the polyethylene membrane. In some embodiments, less than the entire thickness of the porous polyethylene membrane is filled with the hydrophilic polymer, for example, less than or equal to 90% of the thickness of the polyethylene membrane may be filled with the hydrophilic polymer, with the proviso that enough hydrophilic polymer is imbibed so as to provide the porous polyethylene film with a Gurley number of greater than or equal to 1000 seconds. In other embodiments, essentially the entire thickness of the porous polyethylene membrane is filled with the hydrophilic polymer. As used herein, the phrase “essentially the entire thickness” means that at least 90% of the thickness of the porous polyethylene membrane is filled with the hydrophilic polymer.

In some embodiments, the hydrophilic polymer may be applied to the porous polyethylene membrane in a continuous manner, so that essentially 100 percent of the surface area of the porous polyethylene membrane comprises the hydrophilic polymer. As used in this context, the term “continuous” means that the full width or nearly the full width of the porous polyethylene membrane is coated with the hydrophilic polymer.

It should be noted that in many coating processes, the edges of a roll of material may not be coated due to frames or dams at the edges not allowing the entire width of the membrane to be coated. In other embodiments, the hydrophilic polymer may be applied to the porous polyethylene membrane in a discontinuous manner. As used in this context, the term “discontinuous” means that less than 100 percent of the surface area of the porous polyethylene membrane is coated with the hydrophilic polymer and that portions of the non-edge areas of the porous polyethylene membrane do not contain the hydrophilic polymer. For example, a hydrophilic polymer applied to the porous polyethylene membrane as a series of dots or as a grid of orthogonal lines are to be considered as discontinuous coatings. The area percent of the porous polyethylene membrane that is filled with the hydrophilic polymer can be in the range of from greater than or equal to 20 percent to 100 percent or from 30 percent to less than 100 percent or from 40 percent to less than 100 percent or from 50 percent to less than 100 percent or from 60 to less than 100 percent or from 70 to less than 100 percent or from 80 to less than 100 percent or from 90 to less than 100 percent. In other embodiments, the application of the hydrophilic polymer can be done in a manner that produces a random or non random pattern of dots, polygons, parallel lines, intersecting lines, straight lines, curved lines, or any combination thereof in order to provide the desired percent by area coverage. If oleophobicity is desired in such films, it may be desirable in certain embodiments to include an oleophobic coating, as described otherwise herein.

As a weight ratio, the film can have a ratio of the weight of the hydrophilic polymer (filling at least a portion of the pores of the microporous polyethylene membrane and constituting the cap layer) to the weight of the porous polyethylene membrane in the range of from 30.0 to 0.5. In other embodiments, the weight ratio of the hydrophilic polymer to the polyethylene membrane can be 20.0, 15.0, 10.0, 9.0, 8.0, 7.0, 6.0, 5.0, 4.0, 3.0, 2.0, 1.0, 0.9, 0.8, 0.7, 0.6, 0.5 or any weight ratio in between those numbers.

Suitable hydrophilic polymers can include, for example, polyurethane, polyamide, polyester, epoxy resin, silicone resin, ionomer, or a copolymer or a combination thereof. In other embodiments, nearly any suitable hydrophilic polymer could be used provided that the hydrophilic polymer is capable of having a moisture vapor transmission rate of greater than or equal to 5,000 grams/meter²/day or greater than or equal to 10,000 grams/meter²/day. The hydrophilic polymer can be a thermoplastic or a crosslinkable polymer. In some embodiments, the hydrophilic polymer is a polyurethane and in further embodiments, the polyurethane is a crosslinked polyurethane. Suitable polyurethane polymers can be, for example, polyester urethanes, polyetherurethane or polyether-polyester urethanes. A hydrophilic polymer can be produced or available according to known methods. For example, the methods taught in US 2020/013426, JP2002-069370, the contents of which are incorporated herein by reference in their entireties, all teach methods for obtaining prior hydrophilic polymers, and these teachings can be adapted to obtain a hydrophilic polymer of this disclosure.

In some embodiments where coloring is desired, the color can be add using, for example, a pigmented hydrophilic polymer wherein pigments or dyes have been added to the hydrophilic polymer, resulting in a film having the desired color. In other embodiments, the porous polyethylene film can be colored during the formation of the porous polyethylene membrane according to known methods, for example, master-batching. Therefore, one or both of the porous polyethylene membrane and the hydrophilic membrane can be colored or uncolored. If both the porous polyethylene and the hydrophilic polymer are colored, they can be colored in the same or a similar shade or the colors can be chosen independently of one another. Any of the known pigments or dyes can be used, including organic pigments and dyes, inorganic pigments or dyes, metals, metal oxides, carbon black, titanium dioxide or combinations thereof.

In still further embodiments, the porous polyethylene membrane can be treated with both oleophobic and hydrophilic polymers. For example, in a first step, a first side of the porous polyethylene membrane can be treated with an oleophobic polymer that can coat the walls that define the pores of the porous polyethylene membrane without filling the pores, wherein the oleophobic polymer is provided so that less than the entire thickness of the porous polyethylene membrane is treated with the oleophobic polymer. After an optional drying and curing step for the oleophobic polymer, the second side of the porous polyethylene membrane can be treated with a hydrophilic polymer to fill at least a portion of the remaining thickness of the porous polyethylene membrane, followed by an optional heating and curing step for the hydrophilic polymer and the oleophobic polymer. In these embodiments, the hydrophilic polymer fills only that portion of the porous polyethylene membrane that does not have an oleophobic treatment due to the inability of the hydrophilic polymer to wet the oleophobically treated portion of the porous polyethylene membrane.

In some embodiments, the porous polyethylene membrane may be treated with the oleophobic polymer through greater than or equal to 5 percent of the thickness of the porous polyethylene membrane. In other embodiments, the porous polyethylene membrane may be comprised an oleophobic treatment through less than or equal to 95 percent of its thickness. In still further embodiments, the oleophobic treatment may be present in the range of from 10 to 90 percent of the thickness of the porous polyethylene membrane or from 10 to 80 percent, or from 10 to 70 percent or from 10 to 60 percent or from 10 to 50 percent or from 10 to 40 percent or from 10 to 30 percent or from 10 to 20 percent of the thickness of the porous polyethylene membrane. After treatment of the first side of the porous polyethylene membrane, the second side of the porous polyethylene membrane can be treated with the hydrophilic polymer which can fill any of the remaining thickness of the porous polyethylene membrane and in some embodiments, forms a cap layer of the hydrophilic polymer.

The cap layer is present on at least one surface of the microporous polyethylene film. Therefore, the cap layer can affect the appearance of the film. The cap layer can be formed by applying a hydrophilic polymer to at least one surface of the porous polyethylene film. Generally, hydrophilic polymers may react with moisture etc., in the atmosphere so as to generate gas. Also, when a curing agent is used for the cross-linking of hydrophilic polymer, gas may be generated due to the reaction of the curing agent itself or the reaction between the curing agent and the hydrophilic polymer. As a result, voids may remain in the cap layer after the hydrophilic polymer solidified or cured. The remaining voids in the cap layer may cause diffuse reflection of light, cause unevenness on the surface and affect the appearance of the film. These films, or articles containing them, are often difficult to achieve the desired appearance. As described in more detail herein, the inventors have found that the cap layer being essentially free from voids can be obtained by covering the film containing a porous polyethylene membrane, the hydrophilic polymer and the cap layer with a release layer adjacent to the cap layer until the hydrophilic polymer (which may include a hydrophilic polymer constituting the cap layer) solidifies or cures. The hydrophilic polymer filling the pores of the polyethylene film and the hydrophilic polymer constituting the cap layer are suppressed from contact with moisture in the atmosphere by the release layer, and react with the moisture contained in those hydrophilic polymers or moisture contacted to the opposite side of cap layer to solidify or cure. The type, moisture content, temperature, viscosity of those hydrophilic polymers and the moisture content, temperature of atmosphere may be set appropriately so that the time to solidification or curing is sufficient to minimize the gas generated and/or remaining in the cap layer. Said settings, especially with respect to viscosity, may be adjusted with a view point from easily filling at least some of the pores of the polyethylene membrane with the hydrophilic polymers. It is also preferable to cover the hydrophilic polymer with a release layer as soon as possible after application of the hydrophilic polymer to the film or formation of the cap layer, since contact with moisture and dust in the atmosphere can be suppressed. Preferably, the release layer is not sticking to the solidified or cured cap layer and easily released therefrom. Release layers may be commercially available.

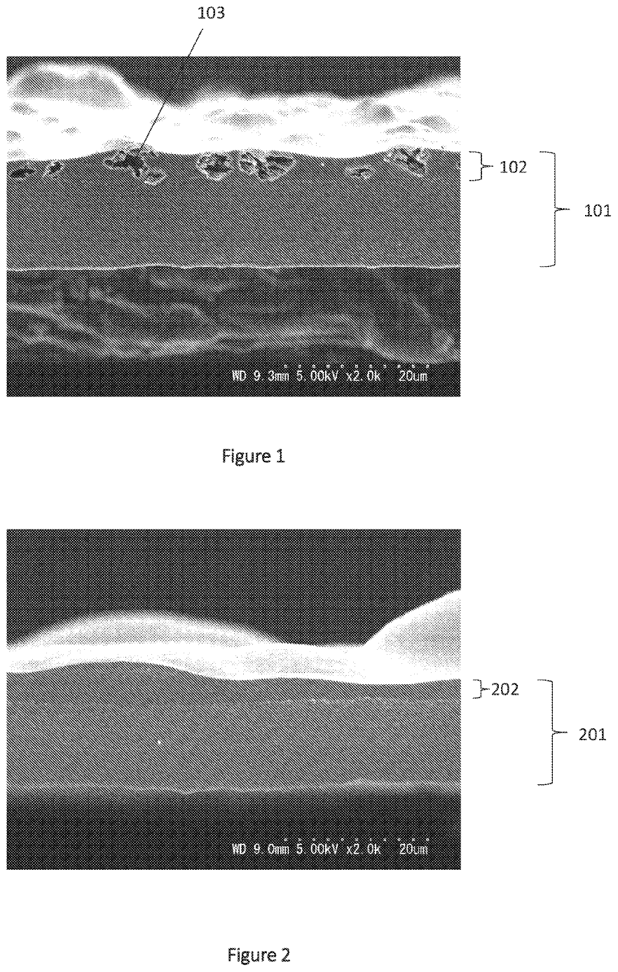

FIG. 1 is an SEM micrograph showing the surface state (cross section) of a film 101 including a cap layer 102 after the gas generated by the reaction of the curing agent mixed with the hydrophilic polymer, forms voids 103 inside the cap layer 102 and solidifies or hardens. FIG. 2 is an SEM micrograph showing the surface state (cross-section) of a film 201 including a cap layer 202 after solidification or curing of the hydrophilic polymer, where the reaction with moisture in the atmosphere has been suppressed by covering it with a release layer. As shown in FIG. 1, voids 103 remain in the conventional cap layer 102. On the other hand, as shown in FIG. 2, the cap layer 202 of this embodiment has no remaining voids. It can be confirmed by visual observation that the appearance differs depending on the presence or absence of voids in the cap layer. It should be noted that FIGS. 1 and 2 denote the respective cap layers 102 and 202 using brackets to indicate the portion of the respective films 101 and 201 that constitutes the cap layer; the brackets should be understood as indicative of the location of the cap layers 102 and 202 in the figures, and not indicative of any particular thickness of the cap layers 102 and 202. Similarly, the brackets indicating the films 101 and 201 should be understood to indicate the location of the films 101 and 201 in the figures, and not indicative of any particular thickness of the films 101 and 201.

The cap layer may have a controlled surface morphology. The cap layer may have a flat surface morphology because it is essentially free from voids. The flat surface morphology can also be textured, embossed, or a combination thereof to produce the desired controlled surface morphology. The controlled surface morphology may include a desired surface roughness, desired dots, lines, or other shapes. The controlled surface morphology can produce the desired appearance. In particular, a cap layer being essentially free from voids may have less diffuse reflection of light and, accordingly, highlight the appearance properties obtained by the controlled surface morphology.

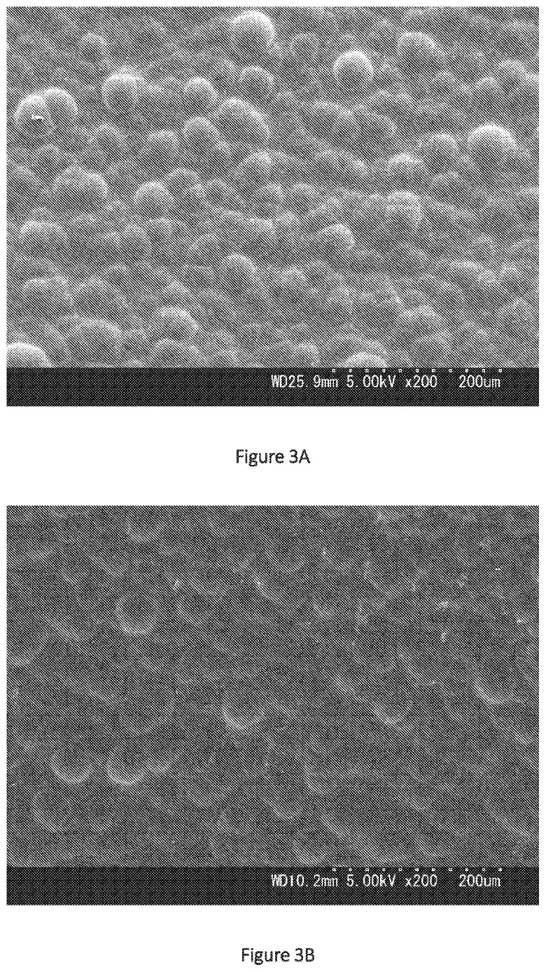

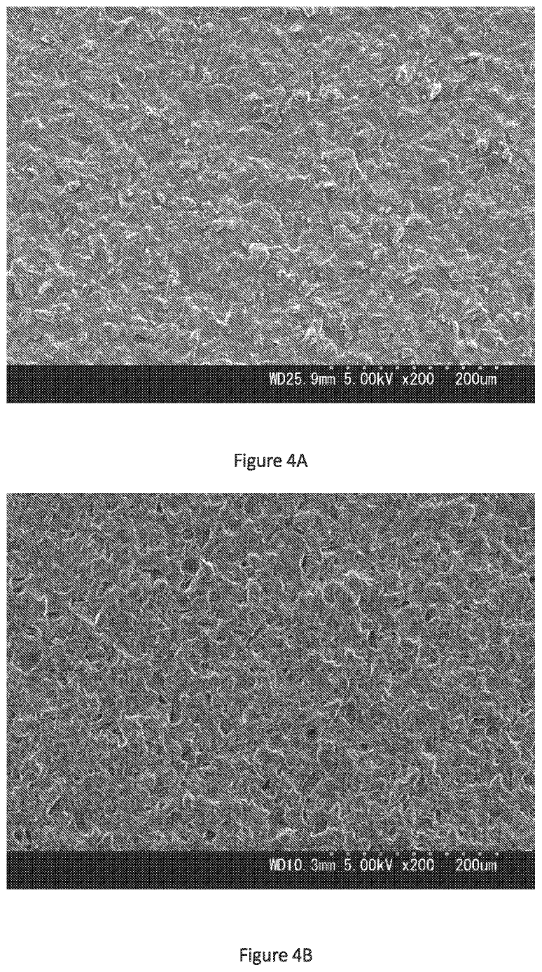

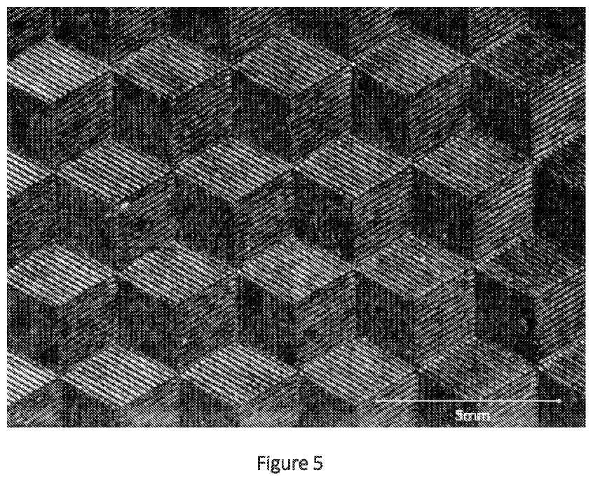

The controlled surface morphology may be the transferred surface of the release layer placed over the cap layer. Since the cap layer is covered by the release layer until the hydrophilic polymer (which may include the hydrophilic polymer constituting the cap layer) solidifies or cures, the surface morphology of the solidified or cured cap layer may be the transfer surface of the release layer. The surface morphology of the release layer may be adjusted so that the cap layer can obtain the desired controlled surface morphology. FIGS. 3A, 3B, 4A, and 4B are SEM micrographs showing the surface morphology of the release layer and the cap layer after the release layer is removed, respectively. FIGS. 3A and 3B show a relatively smooth surface morphology, while FIGS. 4A and 4B show a relatively rough surface morphology.

The film may have an opacity of 10-85%. Opacity of the film is measured by the method specified as ASTM D 2805. The cap layer is essentially free from voids, and the hydrophilic polymer fills at least a portion of the pores of the porous polyethylene film, which accordingly reduce diffuse reflection of light and allow for high transparency. Opacity may be adjusted by adjusting at least one of the controlled surface morphology of the cap layer, the pore filling rate of the porous polyethylene membrane by the hydrophilic polymer, colorization of hydrophilic polymer and colorization of microporous polyethylene membrane. Opacity may be adjusted to 10, 15, 20, 25, 30, 35, 40, 45, 50, 55, 60, 65, 70, 75, 85 or any value between these two values.

The film may have a surface gloss of 3.0 gloss units or more in cap layer. The surface gloss of the cap layer is arbitrarily adjusted according to the needs of the intended use. Gloss measurement is performed on a printed surface at an angle of 85° in the cross-web direction of the sample using a BYK “Micro-TRI-μ Gloss μ” device on a printed surface at an angle of 85° in the cross-web direction of the sample. The data recorded is the average of three individual measurements. Since the cap layer is essentially free from voids, and the hydrophilic polymer fills at least some of the pores of the porous polyethylene film, and therefore light diffuse reflection is low and the desired gloss can be easily adjusted. Glossiness may be adjusted by adjusting at least one of the following: the coloring of the hydrophilic resin, the pore filling rate of the porous polyethylene membrane by the hydrophilic polymer, or the controlled surface morphology of the cap layer.

In general, polymers including the polyethylene membrane disclosed herein, have a molecular weight that is reported as one or more of an average molecular weight (for example, 500,000 gram/mole or more). The actual molecular weight of the individual polymers will be a distribution of molecular weights and the actual molecular weights of the individual polymers will include a portion that is above and a portion that is below the reported average molecular weight. In the present disclosure, the breathability of the film, as determined by the moisture vapor transmission rate, can be affected by the heat treatment step in combination with the molecular weight of the polyethylene. For example, if a relatively large portion of lower molecular weight polymers is present and the thickness of the unfilled region of the polyethylene membrane is too large, then the heat treatment step can result in deformation, for example, collapse of the unfilled region of the polyethylene membrane and result in a decrease or even a loss of breathability of the film. However, if the average molecular weight of the polyethylene is substantially higher and the molecular weight distribution is small enough so that there is little or no low molecular weight polyethylene, heating the film above the melting temperature of polyethylene may not cause the polyethylene membrane structure to deform or collapse even if the polyethylene structure is not imbibed with hydrophilic polymer. The heat treatment can be done in an oven, by running the film over a heated roll or any other known heat treatment method. It should be noted that this heat treatment step resulting in a change in mechanical properties of the film can be done at any point after the polyethylene membrane has been coated with hydrophilic polymer and the hydrophilic polymer (which may include the polyethylene membrane constituting the cap layer) has solidified. That is, the heat treatment step can be performed before or after peeling off the release layer after the hydrophilic polymer is cured, as long as the heat treatment temperature is within a temperature range in which the release layer does not melt or deform. In some embodiments the polyethylene membrane can be coated with hydrophilic polymer to form the film and then the film can be laminated to another layer. Alternatively, in other embodiments the membrane can be laminated to another layer and then the membrane can be coated with hydrophilic polymer. In either embodiment, the heat treatment step can be completed after the film has been made and before, during or after the formation of the laminate.

A film comprising the porous polyethylene membrane and the hydrophilic polymer can be produced according to the steps:
1) providing a porous polyethylene membrane having a weight average molecular weight of greater than 500,000 g/mole, a porosity of at least 40 vol % and a Gurley number of less than 200 seconds;
2) coating at least a portion of the porous polyethylene membrane with a hydrophilic polymer:
3) forming a cap layer constituted of the hydrophilic polymer on the hydrophilic polymer-coated side of the porous polyethylene membrane;
4) covering the cap layer (on the side opposite the porous polyethylene membrane) with a release layer; and
5) solidifying or curing the hydrophilic polymer.

In another embodiment, a film can be produced according to the steps:
1) providing a porous polyethylene membrane having a weight average molecular weight of greater than 500,000 g/mole, a porosity of at least 40 vol % and a Gurley number of less than 200 seconds;
2) coating a first side of the porous polyethylene membrane with an oleophobic polymer to coat the walls that define the pores of the porous polyethylene membrane;
3) coating a second side of the porous polyethylene membrane with a hydrophilic polymer to form the film;
4) forming a cap layer constituted of the hydrophilic polymer on the second side of the porous polyethylene membrane;
5) covering the cap layer (on the side opposite the porous polyethylene membrane) with a release layer; and
6) solidifying or curing the hydrophilic polymer.

In another embodiment, an article can be produced according to the steps:
1) providing a porous polyethylene membrane having a weight average molecular weight of greater than 500,000 g/mole, a porosity of at least 40 vol % and a Gurley number of less than 200 seconds;
2) coating at least a portion of the porous polyethylene membrane with a hydrophilic polymer to form the film,
3) forming a cap layer constituted of the hydrophilic polymer on the hydrophilic polymer-coated side of the porous polyethylene membrane;
4) covering the cap layer (on the side opposite the porous polyethylene membrane) with a release layer;
5) solidifying or curing the hydrophilic polymer; and
6) laminating the film to at least one other layer.

In another embodiment, an article can be produced according to the steps:
1) providing a porous polyethylene membrane having a weight average molecular weight of greater than 500,000 g/mole, a porosity of at least 40 vol % and a Gurley number of less than 200 seconds;
2) laminating at least one other layer to a first side of the porous polyethylene membrane:
3) coating at least a portion of the second side of the porous polyethylene membrane with a hydrophilic polymer:
4) forming a cap layer constituted of the hydrophilic polymer on the second side of the porous polyethylene membrane;
5) covering the cap layer (on the side opposite the porous polyethylene membrane) with a release layer;
6) solidifying or curing the hydrophilic polymer.

Optionally, any of the above methods may include the following process embodiments. The hydrophilic polymer (e.g., polyurethane, etc.) may be layered on a porous polyethylene membrane at room temperature and the composite may be left at room temperature with enough moisture in the atmosphere. For the layering, any process is available such as coating method. The process may be done at room temperature, lower or higher temperature to make a composite as far as the hydrophilic polymer can be cured. If needed, a release layer may be layered on the coated side of the composite. The composite may be left in condition with temperature (cool-room-high) and certain level of humidity which is adjustable to cure the hydrophilic polymer in the composite. The thickness of the cap layer is adjusted with the amount of hydrophilic polymer applied as described as US2021817276 AA.

The resulting film comprising the porous polyethylene membrane, the hydrophilic polymer filing the pores of the membrane and constituting a cap layer can have a moisture vapor transmission rate (MVTR) of greater than or equal to 2500 grams/meter²/day (g/m²/day); a weight of less than 30 grams/meter² and, optionally, a Gurley of greater than or equal to 1000 seconds. In order to be breathable. i.e., moisture vapor is able to be transported from one side of the film to the other without liquid water moving through the film, the MVTR should be greater than or equal to 2500 g/m²/day. In other embodiments, the film can have an MVTR of greater than or equal to 3000 g/m²/day, greater than or equal to 3500 g/m²/day, greater than or equal to 4000 g/m²/day, greater than or equal to 4500 g/m²/day, greater than or equal to 5000 g/m²/day, greater than or equal to 5500 g/m²/day, greater than or equal to 6000 g/m/day, greater than or equal to 6500 g/m²/day, greater than or equal to 7000 g/m²/day, greater than or equal to 7500 g/m²/day, greater than or equal to 8000 g/m²/day, greater than or equal to 8500 g/m²/day, greater than or equal to 9000 g/m/day, greater than or equal to 9500 g/m²/day, or greater than or equal to 10,000 g/m²/day.

The film can also have a ratio of matrix tensile strengths in two orthogonal directions in the range of from 0.5 to 2.0. In other embodiments, the ratio of tensile strengths in two orthogonal directions can be in the range of from 0.7 to 1.4. In still further embodiments, the ratio of tensile strengths can be 0.5, 0.6, 0.7, 0.8, 0.9, 1.0, 1.1, 1.2, 1.8, 1.4, 1.5, 1.6, 1.7, 1.8, 1.9, 2.0 or any value in between those two numbers. The difference in tensile strength in the two orthogonal directions is largely caused by differences in the total strain applied in the two directions during the membrane manufacturing process.

The film may have a heat resistance of 190° C. or less. In other embodiments, the heat resistance may be 180° C. or less, 170° C. or less, 160° C. or less, 150° C. or less, 140° C. or less, 130° C. or less, 120° C. or less. Here, heat resistance means that the deformation due to thermal shrinkage or expansion is small when the material is held at a certain temperature for 60 seconds. For example, the area change may be within 5%, 10%, 15% or 20%.

The film may have a tensile strength in the MD direction (longitudinal direction) of 0.45 kgf or greater. In other embodiments, the tensile strength may be 0.50 kgf or higher, 0.54 kgf or higher, 0.59 kgf or higher, or 0.63 kgf or higher.

The film may have a tensile strength in the TD direction (transverse direction) of 0.36 kgf or greater. In other embodiments, the tensile strength may be 0.41 kgf or higher, 0.45 kgf or higher, 0.50 kgf or higher, or 0.54 kgf or higher.

The film can also be contamination resistant due to the presence of the hydrophilic polymer filling voids in at least a portion of the membrane thickness, thereby forming a continuous layer free from voids in that portion of the porous polyethylene membrane. Furthermore, the cap layer may enhance the contamination resistance of the film. Contamination resistant as used herein means that the films do not become contaminated with sweat, sebum or oils thereby reducing the waterproofness over time. If at least a portion of the pores of the porous polyethylene membrane remain unfilled, then an oleophobic coating on the walls of the unfilled pores can provide contamination resistance to the unfilled pores.

The present disclosure also relates to an article comprising the film. One advantage of an article comprising the film of the present disclosure is that it is easier to obtain the desired appearance with less diffuse reflection of light, when compared to films comprising a cap layer having voids. If the film is in a laminate form, compared to a laminate of a film with a cap layer having voids, the laminate comprising: a cap layer being essentially free from voids; and a hydrophilic polymer filing at least a portion of the pores of the microporous polyethylene membrane can easily achieve a desired variety of appearances. For laminate constructions, other components in the laminate in certain embodiments can contribute to a variety of appearances as well.

The article can be a laminate, for example, one or more layers of the film and one or more other layers laminated together to form the laminate. The one or more other layers can be a textile layer, a polymer layer, a natural leather layer, a synthetic leather layer, a fleece layer, or a combination thereof. In some embodiments, the article can be a 2-layer laminate comprising a textile layer adhered to the first side or the second side of the film. In some embodiments, the article can be a 3-layer laminate comprising a first textile layer adhered to the first side of the film and a second textile layer adhered to the second side of the film. In still further embodiments, additional layers can be applied to produce laminates having 4, 5, 6 or more layers. Suitable textile layers can include any woven, knit, or nonwoven textile. The textiles may be natural and/or synthetic textile, for example, cotton, wool, silk, jute, polyamide, polyester, acrylic, aramid, viscose, rayon, carbon fiber or a combination thereof. Suitable polymer layer can include, for example, polyolefins, polyesters, polyamides, polyurethanes, polyvinyl alcohols, polyvinyl acetates, fluoropolymers, polyvinyl halides, polyvinyl chlorides, epoxy resins, silicon polymers or a combination thereof. Laminates comprising one or more layers of the disclosed film, one or more textile layers and/or one or more polymer layers can also be produced.

Since the disclosed film may have high strength, any of the textile or materials listed above and having a relatively low mass can be used to make the laminate. In some embodiments, the laminate can include a relatively low mass textile having a basis weight in the range of from 5 grams/meter² to 30 grams/meter² (gsm). In other embodiments, the textile can have a mass of 6, 7, 8, 9, 10, 11, 12, 13, 14, 15, 16, 17, 18, 19, 20, 21, 22, 23, 24, 25, 26, 27, 28, 29 or 30 gsm or any value in between two of those values. While relatively low mass textiles can be used, textiles having a weight 30 gsm or greater can also be used. For example, relatively high mass textiles having a mass of as high as 500 gsm could be used.

Lamination techniques are well known in the art and can include, for example, adhesive lamination and heat bonding etc. In some embodiments, the lamination is accomplished via adhesive lamination wherein an adhesive is applied to one or more of the layers to be joined together and the layers are subsequently placed together, optionally with heat and/or pressure, for example, via a nip roller. The adhesive can be applied to the film layer, the textile layer or to both the film and the textile layer. The adhesive can be applied in a discontinuous manner, for example, a series of adhesive dots, shapes, lines, or a combination thereof. In other embodiments, the adhesive can be applied as a continuous layer of adhesive. The adhesive composition can in certain embodiments be a thermoplastic or a crosslinkable adhesive. In still further embodiments, the hydrophilic polymer can be used as the adhesive material for the formation of the laminate. For example, after application of the hydrophilic polymer to one side of the porous polyethylene membrane with the formation of a cap layer of the hydrophilic polymer, a textile can be applied to the hydrophilic polymer and heat and/or pressure can be applied to the laminate in order to ensure that the hydrophilic polymer sufficiently contacts and adheres to the textile. If the hydrophilic polymer is used as the adhesive for the laminate, then the curing step for the hydrophilic polymer can be performed after the textile or other material is placed on the side of the film containing the hydrophilic polymer cap layer. In some embodiments, a heat press can be used to provide sufficient pressure to allow the hydrophilic polymer to flow into the spaces between the textile fibers and the heat from the beat press can perform the desired curing and heat treatment step to create the laminate. In other embodiments, one or more rollers can provide the necessary pressure and/or heat to accomplish the same tasks, for example, in a continuous manner. In a further embodiment, the step of curing the hydrophilic polymer can be performed by curing or hardening the hydrophilic polymer with moisture after the textile or other material has been placed on the side of the film containing the cap layer of hydrophilic polymer.

Laminates having stretch and recovery properties can be produced according to known methods. For example, the methods taught in U.S. Pat. Nos. 4,443,511, 9,950,504, 9,126,390, 9,233,520. U.S. Pat. No. 9,238,844, WO 2018/67529, the contents of which are incorporated herein by reference in their entireties, all teach methods for imparting stretch in prior membranes and laminate constructions, and these teachings can be adapted to provide stretch into laminates comprising a film(s) of this disclosure.

The articles can be, for example, a garment, an enclosure, a protective enclosure, a tent, a sleeping bag, a bivy bag, a backpack, a pack, a cover, and other similar forms benefitting from properties of the films of this disclosure. The garment can be a jacket, a coat, a shirt, pants, a glove, a hat, a shoe, coveralls or at least a portion thereof. Many articles are made from multiple panels that are sewn or otherwise adhered together to form the finished product. Therefore, “at least a portion of” an article means that at least one panel or part of a panel comprises the disclosed film.

The articles and garments can be produced so that the film is on the outside of the garment, on the inside of the garment or wherein the film is at least one of the middle layers of the garment, for example, the middle layer of a 3-layer laminate. One advantage to articles and garments comprising the disclosed film can easily achieve a variety of appearances. Another advantage of the articles and garments is that they can be waterproof and breathable. If the article is required to be waterproof or liquid protective, the stitch holes can be made to liquid-proof by sealing the stitch holes, for example with seam tape. The seam tape can adhere to the article from the outside or the inside of the article.

For those embodiments where the film is on the outside of the garment, meaning that it is the outermost portion of the garment, the film can be colored, uncolored, the film can be texturized, the film can be embossed or any combination thereof to produce the desired appearance. In particular, the film has a cap layer being essentially free from voids, and the hydrophilic polymer fills at least some of the pores of the porous polyethylene film, which reduce diffuse reflection of light and therefore it is easy to obtain the desired appearance. Methods of coloring the film have been described herein. In order to emboss the film, the film can be selectively compressed in a random manner or in a non-random manner, for example, a pattern, letters, words, pictures, a sports team logo, a business logo or a combination thereof could be embossed into the membrane or the film either prior to treatment with the hydrophilic polymer or after treatment with the hydrophilic polymer or both. Selectively compressing can result in differing areas of translucency of the film, which can also alter the breathability of the film, with the embossed areas having relatively lower breathability than the non-embossed areas. Suitable methods of embossing can be found in US20080143012, which is herein incorporated by reference in its entirety.

For those embodiments wherein the film is on the outside of the garment, meaning that it is the outermost portion of the garment, at least a portion of the film can be texturized. The film can be texturized by treating the film with a random or a non-random pattern of an abrasion-resistant polymer. The abrasion-resistant polymer can be applied as a series of dots, lines, or other shapes in order to provide the desired appearance as well as providing improved abrasion-resistance to the outermost portion of the garment. In particular, the film has a cap layer being essentially free from voids, and the hydrophilic polymer fills at least some of the pores of the porous polyethylene film, which reduce diffuse reflection of light and therefore it is easy to obtain the desired appearance. Suitable abrasion-resistant polymers and methods for applying them can be found in US 2010/0071115, which is incorporated herein by reference in its entirety. Another method for texturizing the film can include the application of flock to at least a portion of the film. Suitable methods of applying flock material can be found in WO 99/39038, which herein is incorporated by reference in its entirety.

It has also been found that the film and articles, for example, laminates comprising the film can be provided with an essentially permanent crease without the need for additional chemistries that are currently in use today. This can be useful, especially in garments comprising the film and at least one textile layer, for example, pants. It has been found that a laminate comprising the film and a textile that has been placed in an embroidery hoop and heated followed by cooling, when removed from the embroidery hoop exhibited a crease at the portion of the laminate where the laminate was secured in the embroidery hoop. The heating temperature should be greater than or equal to 125° C., or greater than or equal to 130° C. and less than or equal to 190° C. In embodiments wherein a crease is desired, for example, in a garment, the crease can be produced by folding the article and pressing with heat.

### EXAMPLES

In the following, examples will be used to illustrate the embodiments of the invention. These examples do not limit the scope of the invention.

### Test Methods

### Molecular Weight

Molecular weight determinations were performed according to the procedures given by Mead, D. W., Determination of Molecular Weight Distributions of Linear Flexible Polymers from Linear Viscoelastic Material Functions, Journal of Rheology 1994, 38 (6): 1797-1827.

### Porosity

Porosity was expressed in percent porosity and was determined by subtracting the quotient of the average density of the porous polyethylene membrane and that of the true density of the polymer from 1, then multiplying that value by 100. For the purposes of this calculation, the true density of polyethylene was taken to be 0.94 grams/cubic centimeter. The density of a sample was calculated by dividing the mass/area of a sample by its thickness.

### Moisture Vapor Transmission Rate Test Protocol

MVTR is measured according to DIN EN ISO 15496 (2004). As this is a standard test used in the textile industry, reference is made to the detailed description of the MVTR test disclosed in DIN EN ISO 15496 (2004). For a description of the MVTR test, see also WO 90/04175 A1.

The basic principles are summarized as follows. The sample to be tested together with a highly water vapor permeable, but waterproof microporous membrane is inserted in an annular sample support. Then, the support is immersed in water for 15 minutes (deionized water at 23° C.) such that the membrane contacts the water. A cup is filled with a saturated solution of potassium acetate in water such as to produce a relative humidity of 23% at the surface of the sample and is covered with a second piece of the same waterproof microporous membrane. The cup including the potassium acetate solution and the second membrane is weighed and then placed on top of the sample support such that the second membrane contacts the sample. This leads to a transfer of water vapor through the sample from the side of the water into the cup with the potassium acetate. After 15 minutes, the cup with the potassium acetate is removed and its weight is determined. The same procedure is carried out with the first and second membranes, but without the sample, in order to determine moisture vapor permeability of the test setup without the sample. Then, the MVTR of the sample can be determined from the difference of both measurements, also considering the influence of the two additional microporous membranes.

The moisture vapor transmission rate (MVTR) of the laminate according to the invention was measured in accordance with EN ISO 15496 (2004) and is expressed in g/m²/24 hr. In order to be considered as water vapor permeable as used herein, the laminate should generally have a water vapor permeability of at least 3000 g/m²/24 hr, preferably at least 8000 g/m²/24 hr and more preferably at least 12000 g/m²/24 hr. MVTR values may be as high as 20000 g/m²/24 hr.

### Gurley

The Gurley air flow test measures the time in seconds for 100 cm³ of air to flow through a 6.45 cm² sample at 12.1 cm of water pressure. The samples were measured in a Gurley Densometer Model 41 10 Automatic Densometer equipped with a Gurley Model 4320 automated digital timer. The reported results are the average of multiple measurements.

### Matrix Tensile Strength (MTS)

To determine MTS, a sample membrane was cut in the longitudinal and transverse directions using an ASTM D412-Dogbone Die Type F. Tensile break load was measured using an INSTRON® 5500R (Illinois Tool Works Inc., Norwood, MA) tensile test machine equipped with flat-faced grips and a 90.72 kg load cell. The gauge length for the grips was set to 8.26 cm and a strain rate of 0.847 cm/s or 14.3%/s was used. After placing the sample in the grips, the sample was retracted 1.27 cm to obtain a baseline followed by a tensile test at the aforementioned strain rate. Two samples for each condition were tested individually and the average of the maximum load (i.e., the peak force) measurements was used for the MTS calculation. The longitudinal and transverse MTS were calculated using the following equation:

$$MTS = ( maximum load / cross \cdot sectional area ) ⋆ ( polymer true density / density of the membrance ) .$$

### Thickness Measurements

Membrane thickness was measured by placing the membrane between the two plates of a Kafer FZ1000/30 thickness snap gauge (Kafer Messuhrenfabrik GmbFI. Villingen-Schwenningen, Germany). The average of the three measurements was used.

### Mass Per Unit Area (in Gram/Meter²)

The mass per area (mass/area) of a sample was calculated by measuring the mass of a well-defined area of the sample using a scale. The sample was cut to a defined area using a die or any precise cutting instrument.

### Color Analysis

Spectrophotometer Color 15 (X-Rite Incorporated, Grand Rapids, MI) was used to measure the tristimulus values of film sample indicated by XYZ in the CIE 1931 XYZ color space and CIELAB color space, referred to as L*a*b*. The aperture size was set to 8 mm. Color measurements were taken with white and black color behind the film as the background color. The obtained stimulus values were X, Y and Z over white and X, Y and Z over black, respectively. As for the CIELAB color space, obtained value were L*, a* and b* over black and L*, a*, b* over white. A calibration tile was used for the white background and a black trap for calibration was used for the black background. Of the XYZ stimulus values, the Y stimulus value is known to indicate the luminous transmittance. The opacity Op (%) of the film was obtained by the following formula.

$$Op ( \% ) = ( {Y}_{over black} / {Y}_{over white} ) \times 100$$

### Gloss

Measurements for gloss were taken on the polymer coated surface at an 85° angle in the cross-web direction of the sample, using a BYK “micro-TRI-gloss p” device. Data reported is the average of 3 individual measurements.

### Heat Resistance Test

For the evaluation of the heat resistance of the film, three films were cut into 150 mm squares. A 100 mm square was printed on the film surface with heat-resistant ink. A sample was hooked in a convection oven (ST-120, ESPEC CORP., Osaka) without tension and heated at the set temperature for 30 seconds. After heating, the sample was removed from the oven, and after cooling, the lengths of the four sides of the square were measured. The dimensional change rate D_{LMD}, D_{LTD} (%) and area change rate D_{Area} (%) of the sample were calculated from the average value L_{MD2}, L_{TD2} (mm) of the length of each side after heating against the initial length before heating L_{MD1}, L_{TD1} (mm). The dimensional change rate and area change rate were calculated by the following formulas.

$${D}_{LMD} ( \% ) = ( {L}_{MD 2} - {L}_{MD 1} ) / {L}_{MD 1} \times 100$$

$${D}_{LTD} ( \% ) = ( {L}_{TD 2} - {L}_{TD 1} ) / {L}_{TD 1} \times 100$$

$${D}_{Area} ( \% ) = ( ( {L}_{MD 2} \times {L}_{TD 2} ) - ( {L}_{MD 1} \times {L}_{TD 1} ) ) / ( {L}_{MD 1} \times {L}_{TD 1} ) \times 100$$

### Washing Treatment

Laminate fabric samples cut into 350 mm square was conducted to washing treatment with a synthetic detergent for washing (“Attack Bio EX” made by Kao corporation) using a commercially available an automatic washing machine (“NA-F70PB2” made by Panasonic Corporation), and was then set out to dry at room temperature, constituting one cycle. Samples was repeatedly washed this cycle 5 times. Washing lasted 6 minutes using 40 liters of tap water and 24 grams of detergent, and the sample was rinsed twice and drained for 5 minutes.

### Water Penetration Test

The water penetration test was conducted using a water resistance testing device described in the low water pressure method in JIS L 1092 (“Schopper Type Water Penetration Tester” (WR-1600M, DAIEI KAGAKU SEIKI MFG. CO., LTD, Kyoto). A water pressure of 9.8 kPa was applied to the laminated sample from textile side for 1 minute, then when water appeared on the surface of the fabric opposite the side to which the water pressure was applied, it was determined water resistance was not satisfactory, and water resistance was deemed satisfactory when no water was observed.

### SEM

The surface and cross-section of polymer coated film was observed by using an electron microscope at a magnification of 200 time for the surface and 2000 times for the cross section, respectively. As the electron microscope, the “scanning electron microscope S-3000H” available from Hitachi High-Tech Corporation was used.

### Example 1

### (Polyethylene Membrane)

A 30 micron thick polyethylene membrane (available from Gelon LIB co., Ltd in China) having a weight average molecular weight of 769,000 grams/mole was stretched in the MD 1.5:1 and then stretched in the TD 5:1. The resulting polyethylene membrane mass was 4.1 grams/meter², the thickness was 13.9 microns, the Gurley was 32.7 seconds and the porosity was 69%.

### (Hydrophilic Polymer)

Hydrophilic Prepolymer B was prepared according to the teachings of U.S. Pat. No. 6,720,401 (equivalent to JP4788020 B2) to provide an isocyanate group containing prepolymer.

### (Release Liner)

The release liner made by LDPE was “Pearskin finish Natural” 40 micron supplied from the company of Hayashikazuji Co., Ltd. The thickness was 40 microns, and the surface finish was pear-skin for one side and smooth for another.

### (Composite Film)

The polyethylene membrane described above was coated with the Prepolymer B described above by gravure printing method (20 cm³/m² of cell volume, 70% of surface cover ratio, 100 lines/inch) at 10 m/min of printing speed at 25 degrees C. The coating laydown of the Prepolymer B was 10 grams/meter². Immediately after the prepolymer B was printed on the porous polyethylene membrane, a release liner was overlaid on the printing surface, passed through the roller, and sufficiently pressed. In this process, the smooth surface side of the release liner was faced to the coated side of the membrane. The composite film changed from cloudy appearance to translucent appearance by spreading and penetrated Prepolymer B into the porous polyethylene membrane. The resulting product (i.e., composite film) was left in the room condition for 12 hours (the temperature: 25 degrees C., relative humidity: 70%) for curing the Prepolymer B by the reaction with moisture in the air. After the completion of curing, the release liner was removed from the composite film, hydrophilic polyurethane coated polyethylene film “Example 1 film” was obtained. Mass per unit area, thickness, Gurley, and moisture permeability, were measured. The results are shown in Table 1.

### Example 2

(Composite film) Example 2 film was obtained by carrying out of the film manufacturing process under the same processing condition as Example 1 except that the coating laydown of the Prepolymer B was 15 grams/meter² by using different gravure printing pattern (30 cm³/m² of cell volume, 70% of surface cover ratio, 100 lines/inch), and the pear skin side of the release liner on the printed side of the membrane was overlayed.

The testing results of Example 2 film are shown in Table 1.

### Example 3

### (Polyethylene Membrane)

A 30 micron thick polyethylene membrane (available from Gelon LIB co., Ltd in China) having a weight average molecular weight of 769,000 grams/mole was stretched in the MD 2.25:1 and then stretched in the TD 9:1. The resulting polyethylene membrane mass was 2.1 grams/meter², the thickness was 10.0 microns, the Gurley was 8.7 seconds and the porosity was 78%.

### (Composite Film)

Example 3 film was obtained by carrying out of the film manufacturing process under the same processing condition as Example 1 except that 2.1 grams/meter² of polyethylene membrane described above was used as composite, prepolymer B was printed on the pear-skin side of the release liner and prepolymer B printed release liner was laminated with polyethylene membrane. The testing results of Example 3 film are shown in Table 1.

### Example 4

### (Silver Colored Hydrophilic Prepolymer)

Silver colored hydrophilic prepolymer (prepolymer SV) was obtained by mixing 150 grams of MCF #1000 Carbon black (Mitsubishi Chemical Corporation, Tokyo), 670 grams of EMR-DZ510 (Toyo Aluminium K.K., Osaka) and 9,180 grams of Prepolymer B by kneader mixer. An isocyanate group content of prepolymer SV was 6.8 weight % and a viscosity was 18,000 mPa·sec of this prepolymer.

### (Composite Film)

Example 4 film was obtained by carrying out of the film manufacturing process under the same processing condition as Example 1 except that prepolymer SV was applied instead of prepolymer B, the coating laydown of the Prepolymer SV was 15 grams/meter² by using different gravure printing pattern (30 cm³/m² of cell volume, 70% of surface cover ratio, 100 lines/inch).

The testing results of Example 4 film are shown in Table 1.

### Example 5

### (Release Liner)

The release liner made by polyethylene film laminated paper, Asahi release “cube-2M” (Asahi Roll Co., Ltd., Tokyo) was used. The total thickness of release liner was 150 microns. This release liner has like unique embossed geometric pattern on the polyethylene film laminated side of release liner.

### (Composite Film)

Example 5 film was obtained by carrying out of the film manufacturing process under the same processing condition as Example 1 except that Asahi release “cube-2M” release liner was applied to laminate on the prepolymer printed side instead of release liner described in Example 1.

The testing results of Example 5 film are shown in Table 1.

### Example 6

### (Black Colored Hydrophilic Prepolymer)

Black colored hydrophilic prepolymer (prepolymer BR) was obtained by mixing 150 grams of MCF #1000 Carbon black (Mitsubishi Chemical Corporation, Tokyo) and 9850 grams of Prepolymer B by kneader mixer. An isocyanate group content of prepolymer BK was 7.0 weight % and a viscosity was 15,000 mPa·sec.

### (Composite Film)

Example 6 film was obtained by carrying out of the film manufacturing process under the same processing condition as Example 1 except that prepolymer BK was applied instead of prepolymer B, 2.1 grams/meter² of polyethylene membrane described in Example 3 was used as composite. The testing results of Example 6 film are shown in Table 1.

### Example 7

### (Hydrophilic Prepolymer)

HYPOL™ JT6005 (The Dow Chemical Company, Midland, MD) prepolymer is TDI-based polyurethane prepolymer having an isocyanate group content of 3.0 weight % and a viscosity of 12,000 mPa·sec.

### (Composite Film)

Example 7 film was obtained by carrying out of the film manufacturing process under the same processing condition as Example 1 except that HYPOL™ JT6005 was applied instead of prepolymer B.

The testing results of Example 7 film are shown in Table 1.

### Comparative Example 8

### (Hexamethylene Diamine Carbamate (HMDC) Paste Preparation)

Hexamethylene diamine carbamate (HMDC) paste was prepared according to the teachings of U.S. Pat. No. 5,209,969 as following procedure.

100 parts by mass of hexamethylene diamine (HMD) were added to 244 parts by mass of an ethylene/propylene oxide diol having a hydroxyl value of 110 at 45 degrees C. and normal pressure, and the resulting mixture was bubbled with CO₂ to form a paste solid content of 35 mass %. The reduction in the content of free HMD separated was monitored by titration until the HMD in the paste was converted to HMD carbamate, and the reaction was immediately stopped as soon as the free HMD had disappeared.

### (Mixture of HMDC Paste and Prepolymer B)

91 parts by mass of prepolymer B and 9 parts of HMDC paste was mixed by kneader mixer and obtained “coating mix A”.

### (Coating and Cure Process)

“Coating mix A” was heated up to 50 degrees C. and coated on one side of the polyethylene membrane surface described in Example 1 using roll coater at 10 meter/min. Coating amount was controlled at 10 grams/meter². Polyethylene membrane coated by coating mix A was cut 30 cm square and pinned 4 sides of the square to fix the shape, put into the convection oven adjusted 180 degree C. for 1 minute to activate the reaction between prepolymer Band HMD by de-blocking the CO₂ from diamine. However, the polyethylene membrane coated by coating mix A was melted in the convection oven immediately and coated film was not obtained.

### Comparative Example 9

Polyethylene membrane coated by coating mix A describe in comparative Example 8 was cut 30 cm square and pinned 4 sides of the square to fix the shape, put into the convection oven adjusted 145 degree C. for 30 seconds to activate the reaction between prepolymer B and HMD by de-blocking the CO₂ from diamine. Coating mix A was changed to solid after the heating process, kept in a constant-temperature and constant-humidity chamber of 25 degrees C. and 70% RH for 12 hours to completely cure the coating mix A and obtained Comparative Example 9 film.

The testing results of Comparative Example 9 film are shown in Table 1.

### Comparative Example 10

(Expanded Polytetrafluoroethylene Membrane (ePTFE))

ePTFE membrane available (W. L. Gore & Associates, Newark, DE) which have 20 grams/meter² of membrane mass, 40 microns of thickness, 6 seconds of Gurley and 80% of the porosity was prepared.

### (Coating and Cure Process)

“Coating mix A” described in Comparative Example 8 was heated up to 50 degrees C. and coated on one side of the ePTFE membrane surface described using roll coater at 10 meters/min. Coating amount was controlled at 10 grams/meter², ePTFE membrane coated by coating mix A was cut 30 cm square and pinned 4 sides of the square to fix the shape, put into the convection oven adjusted 180 degree C. for 1 minute to activate the reaction between prepolymer B and HMD by de-blocking the CO₂ from diamine. Coating mix A was changed to solid after the heating process, kept in a constant-temperature and constant-humidity chamber of 25 degrees C. and 70% RH for 12 hours to completely cure the coating mix A and obtained Comparative Example 10 film.

The testing results of Comparative Example 10 film are shown in Table 1.

### Comparative Example 11

Polyethylene microporous membrane described in Example 1 was tested as Comparative Example 11 film without any additional treatment.

The testing results of Comparative Example 11 film are shown in Table 1.

### Comparative Example 12

### (Mixture of HMDC Paste and Prepolymer BK)

9 parts of HIMDC pasto described in Comparative Example 8 and 91 parts by mass of prepolymer BK described in Example 6 were mixed by kneader mixer and obtained “coating mix B”.

### (Coating and Cure Process)

“Coating mix B” was heated up to 50 degrees C. and coated on one side of the polyethylene membrane surface described in Example 3 using roll coater at 10 meter/min. Coating amount was controlled at 10 grams/meter². Polyethylene membrane coated by coating mix B was cut 30 cm square and pinned 4 sides of the square to fix the shape, put into the convection oven adjusted 145 degree C. for 1 minute to activate the reaction between prepolymer BK and HMD by de-blocking the CO₂ from diamine. Coating mix B was changed to solid after the heating process, kept in a constant-temperature and constant humidity chamber of 25 degrees C. and 70% RH for 12 hours to completely cure the coating mix B and obtained Comparative Example 12 film.

The testing results of Comparative Example 12 film are shown in Table 1.

### Comparative Example 13

The prepolymer B made in Example 1 was coated onto the smooth side surface of the release liner described in Example 1 with a Mayor bar at 25 degree C. The amount of coating at this time was 60 g/m². After moisture curing in an environment of 25° C. and 70% humidity for 12 hours, the film was peeled off from the release liner to form a film consisting only of the hydrophilic polymer, which was designated as Comparative Example 13 film. The thickness of this film was about 70 μm.

### Testing Results in Film Level

As summarized in Table 1, films obtained from Examples 1-7 and Comparative Examples 9 and 12 showed excellent light-weight-ness, non-air-permeability, and moisture permeability. Comparative Example 10 film showed relatively thick and heavy weight than the other examples. Comparative Example 11 film which has no hydrophilic polymer coating showed air permeability as porous membrane.

TABLE 1

| | Film Mass | Average | | Moisture |
|---|---|---|---|---|
| | per Area | thickness | Gurley | permeability |
| Example # | (g/m²) | (μm) | (seconds) | (g/m2*24 hours) |
| Example 1 | 14.3 | 15 | >3,000 | 11,800 |
| Example 2 | 19.5 | 20 | >3,000 | 11,000 |
| Example 3 | 11.9 | 13 | >3,000 | 14,000 |
| Example 4 | 19.3 | 23 | >3,000 | 9,400 |
| Example 5 | 19.7 | 25 | >3,000 | 10,800 |
| Example 6 | 14.7 | 18 | >3,000 | 11,400 |
| Example 7 | 14.6 | 17 | >3,000 | 13,000 |
| Comp. Ex. 8 | Coating film was not obtained | | | |
| Comp. Ex. 9 | 14.0 | 20 | >3,000 | 15,500 |
| Comp. Ex. 10 | 29.5 | 40 | >3,000 | 16,500 |
| Comp. Ex. 11 | 4.1 | 14 | 32.7 | 80,000 |
| Comp. Ex. 12 | 12.0 | 18 | >3,000 | 12,000 |

### Cross Section Observation by SEM

Cross section of films obtained from Examples 1-7 and Comparative Examples 9, 10 and 12 were observed by scanning electron microscope. At the 2,000 time of magnification, hydrophilic polymer was filled of the pores of the microporous membrane in all films except comparative example 10. Hydrophilic polymer on the coating surface as referred CAP layer was free from voids in Examples 1-7, on the other hand, there were voids in CAP layer in Comparative Examples 9, 10 and 12.

TABLE 2

| Example # | 85° Gloss Unit | Opacity (%) |
|---|---|---|
| Example 1 | 7.1 | 10.3 |
| Example 2 | 3.1 | 11.4 |
| Example 3 | 6.8 | 10.0 |
| Comparative Example 9 | 2.3 | 17.2 |
| Comparative Example 10 | 2.4 | 79.1 |
| Comparative Example 11 | 49.9 | 66.1 |

### Opacity/Gloss

The surface of the polymer coating side of the Example 1 and Example 3 films had a slightly glossy appearance and was highly transparent. Compared to Examples 1 and 3, Example 2 film had a matte finish on the surface of the polymer coating side. On the other hand, the film possessed high transparency similar to Examples 1 and 3.

The Comparative Example 9 film had an overall whitish appearance and a lower transparency than the Example 1 film. In addition, the surface of the polymer coating side had a matte appearance.

The Comparative Example 10 film had opaque white appearance and a matte surface in the polymer coating side.

The Comparative Example 11 film had opaque white appearance as same as the film of Comparative Example 10. On the other hand, surface was glossy compared to other examples.

Table 2 shows the gloss measurement results and the opacity measurement results.

In Examples 1, 2, and 3, the appearance was transparent, and even through the film, the color of the object inside was not greatly impaired. On the other hand, with the Comparative Example 9 film, the color of the object inside the film tended to become cloudy. The film in Comparative Examples 10 and 11, it was difficult to see through the color of the object inside the film by its high opacity.

### Visual Appearance of the Film

The Example 4 film exhibited metallic luster and opacity due to the aluminum pigment on the surface of the polymer coating side. The opacity measurement result of this film was 75%.

The Example 5 film showed a unique appearance, with the pattern of the release liner transferred to the surface of the CAP layer in polymer coating side and the regular cube pattern copied. A micrograph of the cube pattern of the film is shown in FIG. 5.

Example 6 exhibited coal-black color by the carbon pigment mixed hydrophilic polymer coating. On the other hand, Comparative Example 12 became dark gray color in the hydrophilic polymer coating side, even though it was used same carbon contained polymer with Example 6. The difference in film appearance between Example 6 and Comparative Example 12 is considered to be due to the voids contained in the CAP layer of Comparative Example 12 film diffusely reflecting light and adding dark gray color.

### Tensile Test Result

The films obtained in Example 1. Example 3, and Comparative Example 13 were subjected to a tensile test based on the aforementioned ASTM D412. As a result, the average max load values of the example 1 film were MD=0.98 kgf and TD=0.63 kgf, respectively. The average max load values of the Example 3 film were MD=0.60 kgf and TD=0.50 kgf, respectively. On the other hand, the average max load values of the Comparative Example 13 film were only 0.09 kgf in both directions.

### Heat Resistance Test Result

The films obtained in Examples 1 and 3 and Comparative Example 11 were subjected to heat treatment at set temperatures of 150° C. and 170° C. for 30 seconds in the heat resistance test described above, and the area change rate D_{Area} (%) after heat treatment was determined. Table 3 summarizes the measurement results of the area change rate. Examples 1 and 3 did not show large changes in area by the heat treatment, whereas Comparative Example 11 showed a large dimensional change, indicating that heat resistance cannot be obtained with a Polyethylene microporous membrane alone.

TABLE 3

| | DArea (%) @ 150 C./ | DArea (%) @ 170 C./ |
|---|---|---|
| Example # | 30 sec | 30 sec |
| Example 1 | −5.4 | −8.3 |
| Example 3 | −6.3 | −5.9 |
| Comparative | −67 | −82 |

### Laminate Examples

### Nylon Woven Fabric for Face Textile

A plain-woven Nylon fabric without dying process made by Asahi Kasei Corporation configured from 33 dtex, bright filament yarn was prepared. This textile showed translucent appearance.

### Lamination and Water Repellent Finish

### Example 1A

For adhering the face textile described above to the film obtained in the Example 1, a urethane-based moisture curing type hot melt adhesive (“Tyforce NH-320” manufactured by DIC Corporation) was used. A temperature of the adhesive was set to 110 degrees C. Melt of the adhesive was applied to the opposite side surface of hydrophilic polymer coating side of the film in a dot pattern with a gravure roll having a covering rate of 40% such that an amount of adhesive transferred was 5 gram/meter². Then, the face textile and the Example 1 film were press bonded with a roll, and allowed to stand in a constant-temperature and constant-humidity chamber of 40 degrees C. and 80% RH for 24 hours to cure the hot-melt adhesive and obtained 2-layer laminate.

Next, the face fabric in the 2-layer laminate was subjected to a fluorinated water repellent treatment applied to a surface of the face fabric in an amount of more than saturation amount with a kiss coater. The excess dispersion liquid was removed by pressing with a mangle roll.

In this time, an amount of the dispersion liquid absorbed in the face fabric was about 20 gram/meter². The layered product was then dried in a hot-air circulation type oven at the conditions of 140 degrees C. and 30 seconds to give a 2-layer layered product subjected to the water repellent treatment.

### Laminate 10A

Comparative Example 10 film was laminated in the same manner as Example 1A.

### Laminate 11A

Comparative Example 11 film was laminated in the same manner as Example 1A except the heating temperature of water repellent treatment process was 90 degree C. for 60 seconds.

### Laminate Appearance

Laminate Example 1A showed translucent appearance, Laminate Example 10A and 11A showed opaque white appearance came from laminated film color.

### Test Result of the Laminate

### Home Laundry and Water Penetration Test Result

After 5 household washes with detergent, laminate samples obtained above examples were hung at the ambient condition and dried. When the water pressure resistance was measured applying the water pressure from textile side of the laminate, both Example 1A and Example 11A were able to maintain an initial water pressure resistance of 9.8 kPa. On the other hand, in the sample after 5 household washes, no water leakage was confirmed in Example 1A, but water leakage was observed in Example 11A up to 9.8 kPa. In addition, the appearance of the Laminate Example 1A after 5 household washes kept translucent appearance even in the wet areas after the water resistance test and no significant contrast observed between dry area and wet area. The appearance of Example 11A after 5 household washes became translucent in wet area after the water resistance test and caused significant contrast between dry area and wet area. It is considered that this appearance change came from the membrane layer in the laminate changed from opaque white to translucent by wetting of porous layer by water. Through the washing of the laminate sample, detergent contaminated the porous polyethylene membrane and changed the membrane from hydrophobic to hydrophilic property. On the other hand, Example 1A does not have porous layer in the film, accordingly no water entry happened in the film layer by water resistance test.

The laminate of Example 10A were able to maintain water pressure resistance of 9.8 kPa in both before and after 5 household washing and drying cycles. However, the sample after 5 household washing, the laminate appearance changed from opaque white to translucent in the part wetted with water by applying water pressure as same as Example 11A. Even if Example 10A is able to maintain the waterproofness of the laminate after household washing, this appearance change can be a problem that detracts from its aesthetic appearance by creating, for example, regions which appear translucent, and thus have an overall uneven and undesirable appearance, when used as clothing.

While a number of embodiments of the present invention have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

1. A film comprising:
A) a microporous polyethylene membrane,
wherein the microporous polyethylene membrane comprises polyethylene,
wherein the polyethylene has a weight average molecular weight of greater than 500.000 grams/mole,
wherein the microporous polyethylene membrane has a porosity of at least 40 vol %, and
wherein the microporous polyethylene membrane has a Gurley number of less than 200 seconds; and
B) a hydrophilic polymer,
wherein some of the hydrophilic polymer is within at least a portion of pores of the microporous polyethylene membrane, and at least some of the hydrophilic polymer forms a cap layer existing on at least one surface of the microporous polyethylene membrane, and wherein the cap layer is essentially free from voids.

2. The film according to claim 1,
wherein the hydrophilic polymer within the micro porous polyethylene membrane fills substantially all of the pores of the microporous polyethylene membrane.

3. The film according to claim 1, further comprising a release layer, wherein the release layer is adjacent to the cap layer.

4. The film according to claim 1,
wherein the cap layer has a controlled surface morphology.

5. The film according to claim 4, wherein the controlled surface morphology comprises a transfer printed surface from a release layer placed on the cap layer.

6. The film according to claim 1, having an opacity of from 10 to 85.

7. The film according to claim 1, having a heat, resistance of no more than 190 degrees C.

8. The film according to claim 1, having a tensile strength of 0.45 kgf or more in a MD direction.

9. The film according to claim 1, having a tensile strength of 0.36 kgf or more in a TD direction.

10. The film according to claim 1, wherein the hydrophilic polymer comprises a polyurethane, a polyamide, a polyester, an epoxy resin, a silicone resin, an ionomer, or a copolymer or a combination thereof.

11. The film according to claim 1, having a Gurley number of 1000 seconds or more.

12. The film according to claim 1, having a surface gloss of 3.0 gloss units or more.

13. The film according to claim 1, having a moisture vapor transmission rate of 2500 g/m²/day or more.

14. An article comprising the film according to claim 1.

15. The film according to claim 2, further comprising a release layer, wherein the release layer is adjacent to the cap layer.
